(19) United States
(12) Patent Application Publication
(10) Pub. No.: US 2024/0332651 A1
(43) Pub. Date: Oct. 3, 2024

(54) EV BATTERY CHARGING SOLUTION FOR CONTAINERS

(71) Applicant: Midtronics, Inc., Willowbrook, IL (US)

(72) Inventor: Marcel Queren, Nachrodt-Wiblingwerde (DE)

(21) Appl. No.: 18/616,458

(22) Filed: Mar. 26, 2024

Related U.S. Application Data
(60) Provisional application No. 63/492,565, filed on Mar. 28, 2023.

(51) Int. Cl. H01M 10/44; B65D 88/12; H01M 10/42; H01M 10/46; H01M 50/204; H01M 50/249; H02J 7/00

(52) U.S. Cl. CPC H01M 10/441; B65D 88/121; H01M 10/425; H01M 10/46; H01M 50/204; H01M 50/249; H02J 7/0013; H02J 7/0045; H01M 2010/4271; H01M 2220/20

(57) ABSTRACT

A transportable unit includes an enclosure having a plurality of walls that enclose a storage space, one or more batteries or battery packs located in the storage space of the enclosure and a battery maintenance system located in the storage space of the enclosure with the one or more batteries or battery packs. The battery maintenance system has a main unit including high voltage control circuitry coupled to the one or more batteries or battery packs through a high voltage junction box. The high voltage control circuitry is configured to charge the one or more batteries or battery packs during transport of the enclosure.

### CROSS-REFERENCE TO RELATED APPLICATION

The present application is based on and claims the benefit of U.S. provisional patent application Ser. No. 63/492,565, filed Mar. 28, 2023, the content of which is hereby incorporated by reference in its entirety.

### BACKGROUND

The present invention relates to electric vehicles of the types which use battery packs for storing electricity. This includes both hybrid and purely electric vehicles. More specifically, the present invention relates to manufacturing, charging and transportation of such battery packs.

Traditionally, automotive vehicles have used internal combustion engines as their power source. Petroleum as a source of power. However, vehicles which also store energy in batteries are finding widespread use. Such vehicles can provide increased fuel efficiency and can be operated using alternative energy sources.

Some types of electric vehicles are completely powered using electric motors and electricity. Other types of electric vehicles include an internal combustion engine. The internal combustion engine can be used to generate electricity and supplement the power delivered by the electric motor. These types of vehicles are known as “hybrid” electric vehicles.

Operation of an electric vehicle requires a power source capable of providing large amounts of electricity. Typically, electric vehicles store electricity in large battery packs which consist of a plurality of batteries. These electric vehicle batteries (EVB) may be formed by a number of individual cells or may themselves be individual cells depending on the configuration of the battery and battery pack. The packs are large and replacement can be expensive.

EVBs may take minutes or up to hours to charge. Therefore, battery manufacturers may face added time at the end of the production line to charge the manufactured EVBs, which can contribute to manufacturing inefficiencies. Further, the handling, vibration and impact on these batteries and component modules during transportation can cause loss of charge, creating further inefficiencies when in the hands of an end user.

### SUMMARY

A transportable unit includes an enclosure having a plurality of walls that enclose a storage space, one or more batteries or battery packs located in the storage space of the enclosure and a battery maintenance system located in the storage space of the enclosure with the one or more batteries or battery packs. The battery maintenance system includes a main unit having high voltage control circuitry coupled to the one or more batteries or battery packs through a high voltage junction box. The high voltage control circuitry is configured to charge the one or more batteries or battery packs during transport of the enclosure.

A method of charging one or more batteries or battery packs during transport is provided. The method includes placing the one or more batteries or battery packs in a shipping container and coupling the one or more batteries or battery packs to a battery maintenance system located inside the shipping container. The battery maintenance system includes a main unit having high voltage control circuitry that is coupled to the one or more batteries or battery packs through a high voltage junction box. The method further includes charging the one or more batteries or battery packs with the high voltage control circuitry of the battery maintenance system during transport of the shipping container.

A transportable unit comprising includes a shipping container, one or more batteries or battery packs located in the shipping container and a battery maintenance system located in the shipping container and coupled the one or more batteries or battery packs. The battery maintenance system includes a main unit having high voltage control circuitry that is coupled to the one or more batteries or battery packs through a high voltage junction box. The one or more batteries or battery packs are charged with the battery maintenance system during transport of the shipping container.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a simplified block diagram of an electric vehicle.

FIG. 2 is simplified schematic diagram of a battery pack for use in the electric vehicle of FIG. 1.

FIG. 3 is a perspective view of an exterior of a shipping container according to an embodiment.

FIG. 4 is a simplified schematic diagram of an example configuration of a shipping container for transporting batteries and including a battery pack maintenance system according to an embodiment.

FIG. 5 is a simplified block diagram of a battery pack maintenance system in accordance with an embodiment.

### DETAILED DESCRIPTION OF ILLUSTRATIVE EMBODIMENTS

Embodiments of the present disclosure are described more fully hereinafter with reference to the accompanying drawings. Elements that are identified using the same or similar reference characters refer to the same or similar elements. Some elements may not be shown in each of the figures in order to simplify the illustrations.

The various embodiments of the present disclosure may be embodied in many different forms and should not be construed as limited to the specific embodiments set forth herein. Rather, these embodiments are provided so that this disclosure will be thorough and complete, and will fully convey the scope of the present disclosure to those skilled in the art.

Global manufacturers of electric vehicle batteries (EVBs) are facing the issue of having a time-consuming charging process at the end of their production lines. The charging process may consume times that range from minutes to hours, and it is beneficial to run this charging process, or run this charging process after an initial base charge, during a lengthy sea or ground freight transport. Charging and/or maintaining a charge level during transport avoids recharge requirements when a shipment lands or a transport ends. Running a charging process during transport may be applicable to battery cells, modules & packs.

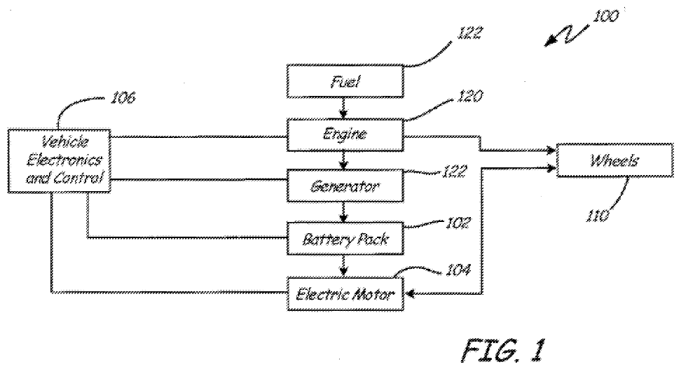

FIG. 1 is a simplified block diagram of an electric vehicle 100. Electric vehicle 100 can be configured to operate solely based upon electric power, or may include an internal combustion engine. Vehicle 100 includes a battery pack 102 and at least one electric motor 104. Vehicle electronics and control system 106 couples to the battery pack and electric motor and is configured to control their operation. Wheels 110 of vehicle 100 are configured to propel the vehicle in response to a mechanical input from electric motor 104. Electric motor 104 operates using energy drawn from the battery 102. In some configurations a regenerative braking system can be used in which a braking energy is recovered from the wheels 110 by the electric motor 104 or other equipment. The recovered energy can be used to recharge the battery pack 102.

FIG. 1 also shows optional components of vehicle 100. These optional components allow the vehicle 100 to operate as “hybrid” vehicle. In such a configuration, an internal combustion engine 120 is provided which operates using, for example, petroleum-based fuel 122. The engine 120 can be configured to directly mechanically drive the wheels 110 and/or an electric generator 122. The electric generator 122 can be configured to charge the battery pack 102 and/or provide electrical power directly to electric motor 104.

The battery pack 102 is a critical component of the electric vehicle 100. Operation of the battery pack 102 will determine the efficiency of the vehicle, the overall range of the vehicle, the rate at which the battery pack 102 can be charged and the rate at which the battery pack 102 can be discharged.

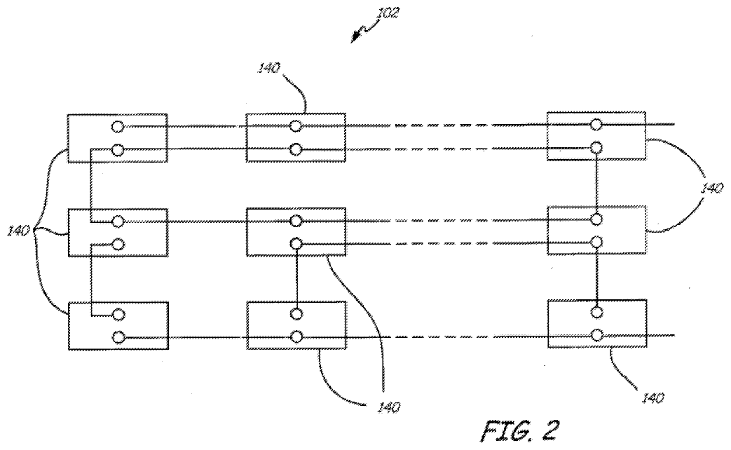

FIG. 2 is a simplified diagram of an example configuration of a manufactured battery pack 102. In FIG. 2, a plurality of individual batteries 140 are shown connected in series and in parallel. Each of the individual batteries 140 may comprise a single cell or may comprise multiple cells connected in series and/or parallel. These may be removable battery modules formed by a single cell or a group of cells. If elements 140 are a group of cells, in some configurations individual connections may be available within the battery and used in accordance with the invention.

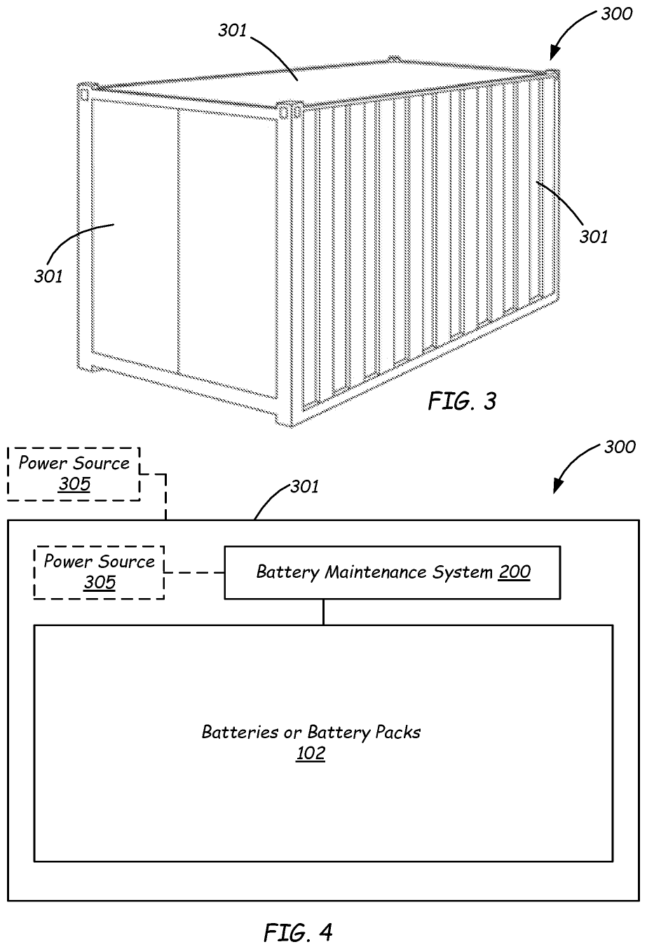

FIG. 3 is a perspective view of an exterior of a transportable unit 300 according to an embodiment. Transportable unit 300 is an enclosure having a plurality of walls 301 that enclose a storage space. Transportable unit 300 may be a large reusable steel box used for intermodal shipments and called an intermodal freight container or shipping container. Transportable unit 300 may be a box made out of other materials. Regardless, transportable unit 300 is designed to be moved from one mode of transport to another without unloading and reloading objects that are stored inside.

FIG. 4 is a simplified schematic diagram of transportable unit 300 configured to transport batteries or battery packs 102 according to an embodiment. In one aspect, transportable unit 300 includes a battery maintenance system 200. System 200 may include an integral central, programmable and monitored battery charging system. Such a transportable unit 300 offers added value to both monitoring batteries and battery packs 102, which may be used for safety measuring, and charging batteries or battery packs 102, such as EVBs, during transport. In addition, battery manufacturers save time in production and third-party service providers would no longer need to charge batteries after transport, which would provide a cost savings. System 300 provides a solution which can be integrated into a transportable unit or shipping container, is robust & reliable enough, can be reused many times and withstands sea and salt environment.

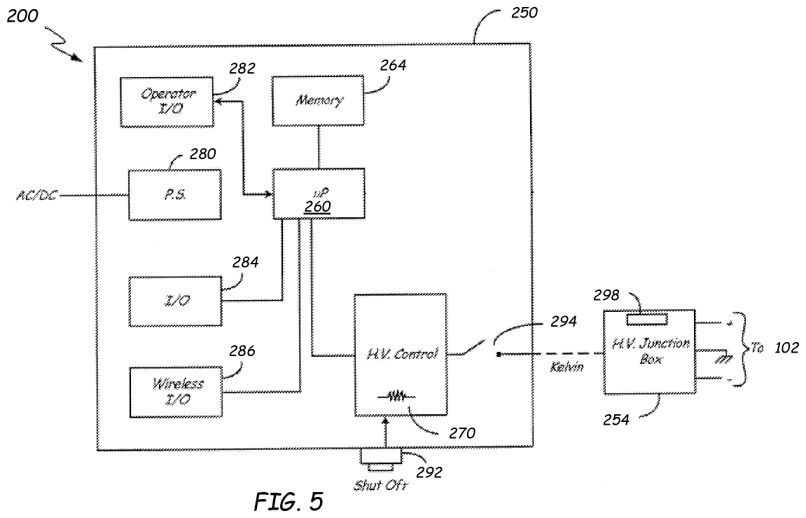

FIG. 5 is a simplified block diagram of battery pack maintenance system 200 in accordance with an embodiment. Battery pack maintenance system 200 includes a main unit 250 which couples to battery pack or battery packs 102 through a high voltage junction box 254. Main unit 250 includes a microprocessor 260 which operates in accordance with instructions stored in a memory 264. A power supply is used to provide power to the system. The power supply 280 can be coupled to an AC power source, or other high-power source, for use in charging battery packs 102 being shipped in container 300. Additionally, the power supply 280 can be coupled to a DC power source, such as another battery, if the system 200 is being used for discharging of battery packs 102. As illustrated in FIG. 4, power source 305 may be located outside the plurality of walls 301 of transportable unit 300 or may be located inside the plurality of walls 301 of transportable unit 300.

Microprocessor 260 may communicate with an operator using an operator input/output 282. Other input/output circuitry 284 is provided for use in physically connecting to a data communication link such as an RS232, USB connection, Ethernet, etc. An optional wireless I/O circuit 286 is also provided for use in communicating in accordance with wireless technologies such as WiFi techniques, Bluetooth®, Zigbee®, etc. FIG. 2 also illustrates an operator shut off switch 292 which can be activated to immediately disconnect the high voltage control 270 from the battery packs 102 using disconnect switch 294. Other circuit configurations can be used to implement this shut off capability. This configuration allows an operator to perform an emergency shut off or otherwise immediately disconnect the system 200 from the battery packs if desired.

In one configuration, the connection between the high voltage control circuitry 270 and the high voltage junction box 254 is through Kelvin type connectors. This can be used to eliminate the voltage drop which occurs when large currents are drawn through wiring thereby provide more accurate voltage measurements. The actual connection between the junction box 254 and the battery pack(s) 102 need not be through a Kelvin connection if the distance between the junction box 254 and the battery pack(s) 102 are sufficiently short for the voltage drop across the connection leads to be negligible. Isolation circuitry such as fuses may be provided in the junction box 254 to prevent the application of a high voltage or current to system 200 and thereby protect circuitry in the system. A visual output and/or input 298 can be provided on the high voltage junction box 254. For example, this may be a display which can be observed by an operator. An example display includes an LED display, or individual LEDs, which provides an indication to the operator regarding the functioning of the low voltage junction box, the vehicle, or the battery pack. This can be used to visually inform an operator regarding the various functions being performed by the high voltage junction box, including voltages detected by the high voltage junction box.

The appropriate high voltage junction box 254 can be selected based upon the particular battery pack or packs 102 being maintained in shipping container 300. Similarly, junction box 254 can be selected based upon the types of connections which are available in a particular situation.

The use of high voltage junction box 254 is advantageous for a number of reasons. The junction boxes can be used to provide a standardized connection to the circuitry of the battery pack maintenance system 100. From junction box 254, specialized connectors can be provided for use with different types of vehicles and/or battery packs. Similarly, different types of junction boxes 254 can be utilized for different vehicles and/or battery packs. The junction box 254 allows a single set cable connection to extend between the main unit 250 and locations in shipping container 300. This provides better cable management, case of use, and increased accuracy.

In addition to use as a load for charging the battery packs 102 or keeping the battery packs 102 charged, the high voltage control circuitry 254 may also optionally include a discharging function for use in discharging the battery and battery packs in container 300.

More recently, techniques have been pioneered by Dr. Keith S. Champlin and Midtronics, Inc. of Willowbrook, Ill. for testing storage battery by measuring a dynamic parameter of the battery such as the dynamic conductance of the battery and charging storage batteries. These techniques are described in a number of United States patents, for example, U.S. Pat. No. 3,873,911, issued Mar. 25, 1975, to Champlin; U.S. Pat. No. 3,909,708, issued Sep. 30, 1975, to Champlin; U.S. Pat. No. 4,816,768, issued Mar. 28, 1989, to Champlin; U.S. Pat. No. 4,825,170, issued Apr. 25, 1989, to Champlin; U.S. Pat. No. 4,881,038, issued Nov. 14, 1989, to Champlin; U.S. Pat. No. 4,912,416, issued Mar. 27, 1990, to Champlin; U.S. Pat. No. 5,140,269, issued Aug. 18, 1992, to Champlin; U.S. Pat. No. 5,343,380, issued Aug. 30, 1994; U.S. Pat. No. 5,572,136, issued Nov. 5, 1996; U.S. Pat. No. 5,574,355, issued Nov. 12, 1996; U.S. Pat. No. 5,583,416, issued Dec. 10, 1996; U.S. Pat. No. 5,585,728, issued Dec. 17, 1996; U.S. Pat. No. 5,589,757, issued Dec. 31, 1996; U.S. Pat. No. 5,592,093, issued Jan. 7, 1997; U.S. Pat. No. 5,598,098, issued Jan. 28, 1997; U.S. Pat. No. 5,656,920, issued Aug. 12, 1997; U.S. Pat. No. 5,757,192, issued May 26, 1998; U.S. Pat. No. 5,821,756, issued Oct. 13, 1998; U.S. Pat. No. 5,831,435, issued Nov. 3, 1998; U.S. Pat. No. 5,871,858, issued Feb. 16, 1999; U.S. Pat. No. 5,914,605, issued Jun. 22, 1999; U.S. Pat. No. 5,945,829, issued Aug. 31, 1999; U.S. Pat. No. 6,002,238, issued Dec. 14, 1999; U.S. Pat. No. 6,037,751, issued Mar. 14, 2000; U.S. Pat. No. 6,037,777, issued Mar. 14, 2000; U.S. Pat. No. 6,051,976, issued Apr. 18, 2000; U.S. Pat. No. 6,081,098, issued Jun. 27, 2000; U.S. Pat. No. 6,091,245, issued Jul. 18, 2000; U.S. Pat. No. 6,104,167, issued Aug. 15, 2000; U.S. Pat. No. 6,137,269, issued Oct. 24, 2000; U.S. Pat. No. 6,163,156, issued Dec. 19, 2000; U.S. Pat. No. 6,172,483, issued Jan. 9, 2001; U.S. Pat. No. 6,172,505, issued Jan. 9, 2001; U.S. Pat. No. 6,222,369, issued Apr. 24, 2001; U.S. Pat. No. 6,225,808, issued May 1, 2001; U.S. Pat. No. 6,249,124, issued Jun. 19, 2001; U.S. Pat. No. 6,259,254, issued Jul. 10, 2001; U.S. Pat. No. 6,262,563, issued Jul. 17, 2001; U.S. Pat. No. 6,294,896, issued Sep. 25, 2001; U.S. Pat. No. 6,294,897, issued Sep. 25, 2001; U.S. Pat. No. 6,304,087, issued Oct. 16, 2001; U.S. Pat. No. 6,310,481, issued Oct. 30, 2001; U.S. Pat. No. 6,313,607, issued Nov. 6, 2001; U.S. Pat. No. 6,313,608, issued Nov. 6, 2001; U.S. Pat. No. 6,316,914, issued Nov. 13, 2001; U.S. Pat. No. 6,323,650, issued Nov. 27, 2001; U.S. Pat. No. 6,329,793, issued Dec. 11, 2001; U.S. Pat. No. 6,331,762, issued Dec. 18, 2001; U.S. Pat. No. 6,332,113, issued Dec. 18, 2001; U.S. Pat. No. 6,351,102, issued Feb. 26, 2002; U.S. Pat. No. 6,359,441, issued Mar. 19, 2002; U.S. Pat. No. 6,363,303, issued Mar. 26, 2002; U.S. Pat. No. 6,377,031, issued Apr. 23, 2002; U.S. Pat. No. 6,392,414, issued May 21, 2002; U.S. Pat. No. 6,417,669, issued Jul. 9, 2002; U.S. Pat. No. 6,424,158, issued Jul. 23, 2002; U.S. Pat. No. 6,441,585, issued Aug. 17, 2002; U.S. Pat. No. 6,437,957, issued Aug. 20, 2002; U.S. Pat. No. 6,445,158, issued Sep. 3, 2002; U.S. Pat. Nos. 6,456,045; 6,466,025, issued Oct. 15, 2002; U.S. Pat. No. 6,465,908, issued Oct. 15, 2002; U.S. Pat. No. 6,466,026, issued Oct. 15, 2002; U.S. Pat. No. 6,469,511, issued Nov. 22, 2002; U.S. Pat. No. 6,495,990, issued Dec. 17, 2002; U.S. Pat. No. 6,497,209, issued Dec. 24, 2002; U.S. Pat. No. 6,507,196, issued Jan. 14, 2003; U.S. Pat. No. 6,534,993; issued Mar. 18, 2003; U.S. Pat. No. 6,544,078, issued Apr. 8, 2003; U.S. Pat. No. 6,556,019, issued Apr. 29, 2003; U.S. Pat. No. 6,566,883, issued May 20, 2003; U.S. Pat. No. 6,586,941, issued Jul. 1, 2003; U.S. Pat. No. 6,597,150, issued Jul. 22, 2003; U.S. Pat. No. 6,621,272, issued Sep. 16, 2003; U.S. Pat. No. 6,623,314, issued Sep. 23, 2003; U.S. Pat. No. 6,633,165, issued Oct. 14, 2003; U.S. Pat. No. 6,635,974, issued Oct. 21, 2003; U.S. Pat. No. 6,696,819, issued Feb. 24, 20144; U.S. Pat. No. 6,707,303, issued Mar. 16, 2004; U.S. Pat. No. 6,737,831, issued May 18, 2004; U.S. Pat. No. 6,744,149, issued Jun. 1, 2004; U.S. Pat. No. 6,759,849, issued Jul. 6, 2004; U.S. Pat. No. 6,781,382, issued Aug. 24, 2004; U.S. Pat. No. 6,788,025, filed Sep. 7, 2004; U.S. Pat. No. 6,795,782, issued Sep. 21, 2004; U.S. Pat. No. 6,805,090, filed Oct. 19, 2004; U.S. Pat. No. 6,806,716, filed Oct. 19, 2004; U.S. Pat. No. 6,850,037, filed Feb. 1, 2005; U.S. Pat. No. 6,850,037, issued Feb. 1, 2005; U.S. Pat. No. 6,871,151, issued Mar. 22, 2005; U.S. Pat. No. 6,885,195, issued Apr. 26, 2005; U.S. Pat. No. 6,888,468, issued May 3, 2005; U.S. Pat. No. 6,891,378, issued May 10, 2005; U.S. Pat. No. 6,906,522, issued Jun. 14, 2005; U.S. Pat. No. 6,906,523, issued Jun. 14, 2005; U.S. Pat. No. 6,909,287, issued Jun. 21, 2005; U.S. Pat. No. 6,914,413, issued Jul. 5, 2005; U.S. Pat. No. 6,913,483, issued Jul. 5, 2005; U.S. Pat. No. 6,930,485, issued Aug. 16, 2005; U.S. Pat. No. 6,933,727, issued Aug. 23, 200; U.S. Pat. No. 6,941,234, filed Sep. 6, 2005; U.S. Pat. No. 6,967,484, issued Nov. 22, 2005; U.S. Pat. No. 6,998,847, issued Feb. 14, 2006; U.S. Pat. No. 7,003,410, issued Feb. 21, 2006; U.S. Pat. No. 7,003,411, issued Feb. 21, 2006; U.S. Pat. No. 7,012,433, issued Mar. 14, 2006; U.S. Pat. No. 7,015,674, issued Mar. 21, 2006; U.S. Pat. No. 7,034,541, issued Apr. 25, 2006; U.S. Pat. No. 7,039,533, issued May 2, 2006; U.S. Pat. No. 7,058,525, issued Jun. 6, 2006; U.S. Pat. No. 7,081,755, issued Jul. 25, 2006; U.S. Pat. No. 7,106,070, issued Sep. 12, 2006; U.S. Pat. No. 7,116,109, issued Oct. 3, 2006; U.S. Pat. No. 7,119,686, issued Oct. 10, 2006; and U.S. Pat. No. 7,126,341, issued Oct. 24, 2006; U.S. Pat. No. 7,154,276, issued Dec. 26, 2006; U.S. Pat. No. 7,198,510, issued Apr. 3, 2007; U.S. Pat. No. 7,363,175, issued Apr. 22, 2008; U.S. Pat. No. 7,208,914, issued Apr. 24, 2007; U.S. Pat. No. 7,246,015, issued Jul. 17, 2007; U.S. Pat. No. 7,295,936, issued Nov. 13, 2007; U.S. Pat. No. 7,319,304, issued Jan. 15, 2008; U.S. Pat. No. 7,363,175, issued Apr. 22, 2008; U.S. Pat. No. 7,398,176, issued Jul. 8, 2008; U.S. Pat. No. 7,408,358, issued Aug. 5, 2008; U.S. Pat. No. 7,425,833, issued Sep. 16, 2008; U.S. Pat. No. 7,446,536, issued Nov. 4, 2008; U.S. Pat. No. 7,479,763, issued Jan. 20, 2009; U.S. Pat. No. 7,498,767, issued Mar. 3, 2009; U.S. Pat. No. 7,501,795, issued Mar. 10, 2009; U.S. Pat. No. 7,505,856, issued Mar. 17, 2009; U.S. Pat. No. 7,545,146, issued Jun. 9, 2009; U.S. Pat. No. 7,557,586, issued Jul. 7, 2009; U.S. Pat. No. 7,595,643, issued Sep. 29, 2009; U.S. Pat. No. 7,598,699, issued Oct. 6, 2009; U.S. Pat. No. 7,598,744, issued Oct. 6, 2009; U.S. Pat. No. 7,598,743, issued Oct. 6, 2009; U.S. Pat. No. 7,619,417, issued Nov. 17, 2009; U.S. Pat. No. 7,642,786, issued Jan. 5, 2010; U.S. Pat. No. 7,642,787, issued Jan. 5, 2010; U.S. Pat. No. 7,656,162, issued Feb. 2, 2010; U.S. Pat. No. 7,688,074, issued Mar. 30, 2010; U.S. Pat. No. 7,705,602, issued Apr. 27, 2010; U.S. Pat. No. 7,706,992, issued Apr. 27, 2010; U.S. Pat. No. 7,710,119, issued May 4, 2010; U.S. Pat. No. 7,723,993, issued May 25, 2010; U.S. Pat. No. 7,728,597, issued Jun. 1, 2010; U.S. Pat. No. 7,772,850, issued Aug. 10, 2010; U.S. Pat. No. 7,774,151, issued Aug. 10, 2010; U.S. Pat. No. 7,777,612, issued Aug. 17, 2010; U.S. Pat. No. 7,791,348, issued Sep. 7, 2010; U.S. Pat. No. 7,808,375, issued Oct. 5, 2010; U.S. Pat. No. 7,924,015, issued Apr. 12, 2011; U.S. Pat. No. 7,940,053, issued May 10, 2011; U.S. Pat. No. 7,940,052, issued May 10, 2011; U.S. Pat. No. 7,959,476, issued Jun. 14, 2011; U.S. Pat. No. 7,977,914, issued Jul. 12, 2011; U.S. Pat. No. 7,999,505, issued Aug. 16, 2011; U.S. Pat. No. D643,759, issued Aug. 23, 2011; U.S. Pat. No. 8,164,343, issued Apr. 24, 2012; U.S. Pat. No. 8,198,900, issued Jun. 12, 2012; U.S. Pat. No. 8,203,345, issued Jun. 19, 2012; U.S. Pat. No. 8,237,448, issued Aug. 7, 2012; U.S. Pat. No. 8,306,690, issued Nov. 6, 2012; U.S. Pat. No. 8,344,685, issued Jan. 1, 2013; U.S. Pat. No. 8,436,619, issued May 7, 2013; U.S. Pat. No. 8,442,877, issued May 14, 2013; U.S. Pat. No. 8,493,022, issued Jul. 23, 2013; U.S. Pat. No. D687,727, issued Aug. 13, 2013; U.S. Pat. No. 8,513,949, issued Aug. 20, 2013; U.S. Pat. No. 8,674,654, issued Mar. 18, 2014; U.S. Pat. No. 8,674,711, issued Mar. 18, 2014; U.S. Pat. No. 8,704,483, issued Apr. 22, 2014; U.S. Pat. No. 8,738,309, issued May 27, 2014; U.S. Pat. No. 8,754,653, issued Jun. 17, 2014; U.S. Pat. No. 8,872,516, issued Oct. 28, 2014; U.S. Pat. No. 8,872,517, issued Oct. 28, 2014; U.S. Pat. No. 8,958,998, issued Feb. 17, 2015; U.S. Pat. No. 8,963,550, issued Feb. 24, 2015; U.S. Pat. No. 9,018,958, issued Apr. 28, 2015; U.S. Pat. No. 9,052,366, issued Jun. 9, 2015; U.S. Pat. No. 9,201,120, issued Dec. 1, 2015; U.S. Pat. No. 9,229,062, issued Jan. 5, 20126; U.S. Pat. No. 9,244,100, issued Jan. 26, 2016; U.S. Pat. No. 9,255,955, issued Feb. 9, 2016; U.S. Pat. No. 9,274,157, issued Mar. 1, 2016; U.S. Pat. No. 9,312,575, issued Apr. 12, 2016; U.S. Pat. No. 9,335,362, issued May 10, 2016; U.S. Pat. No. 9,425,487, issued Aug. 23, 2016; U.S. Pat. No. 9,419,311, issued Aug. 16, 2016; U.S. Pat. No. 9,496,720, issued Nov. 15, 2016; U.S. Pat. No. 9,588,185, issued Mar. 7, 2017; U.S. Pat. No. 9,923,289, issued Mar. 20, 2018; U.S. Pat. No. 9,966,676, issued May 8, 2018; U.S. Pat. No. 10,046,649, issued Aug. 14, 2018; U.S. Pat. No. 10,222,397, issued Mar. 5, 2019; U.S. Pat. No. 10,317,468, issued Jun. 11, 2019; U.S. Pat. No. 10,429,449, issued Oct. 1, 2019; U.S. Pat. No. 10,473,555, issued Nov. 12, 2019; U.S. Pat. No. 10,608,353, issued Mar. 31, 2020; U.S. Pat. No. 10,843,574, issued Nov. 24, 2020; U.S. Pat. No. 11,054,480, issued Jul. 6, 2021; U.S. Pat. No. 11,325,479, issued May 10, 2022; U.S. Pat. No. 11,474,153, issued Oct. 18, 2022; U.S. Pat. No. 11,486,930, issued Nov. 1, 2022; U.S. Pat. No. 11,513,160, issued Nov. 29, 2022; U.S. Pat. No. 11,545,839, issued Jan. 3, 2023; U.S. Pat. No. 11,548,404, issued Jan. 10, 2023; U.S. Pat. No. 11,566,972, issued Jan. 31, 2023; U.S. Pat. No. 11,650,259, issued May 16, 2023; U.S. Pat. No. 11,668,779, issued Jun. 6, 2023; U.S. Pat. No. 11,740,294, issued Aug. 29, 2023; U.S. Ser. No. 09/780,146, filed Feb. 9, 2001, entitled STORAGE BATTERY WITH INTEGRAL BATTERY TESTER; U.S. Ser. No. 09/756,638, filed Jan. 8, 2001, entitled METHOD AND APPARATUS FOR DETERMINING BATTERY PROPERTIES FROM COMPLEX IMPEDANCE/ADMITTANCE; U.S. Ser. No. 09/862,783, filed May 21, 2001, entitled METHOD AND APPARATUS FOR TESTING CELLS AND BATTERIES EMBEDDED IN SERIES/PARALLEL SYSTEMS; U.S. Ser. No. 09/880,473, filed Jun. 13, 2001; entitled BATTERY TEST MODULE; U.S. Ser. No. 10/109,734, filed Mar. 28, 2002, entitled APPARATUS AND METHOD FOR COUNTERACTING SELF DISCHARGE IN A STORAGE BATTERY; U.S. Ser. No. 10/263,473, filed Oct. 2, 2002, entitled ELECTRONIC BATTERY TESTER WITH RELATIVE TEST OUTPUT; U.S. Ser. No. 09/653,963, filed Sep. 1, 2000, entitled SYSTEM AND METHOD FOR CONTROLLING POWER GENERATION AND STORAGE; U.S. Ser. No. 10/174,110, filed Jun. 18, 2002, entitled DAYTIME RUNNING LIGHT CONTROL USING AN INTELLIGENT POWER MANAGEMENT SYSTEM; U.S. Ser. No. 10/258,441, filed Apr. 9, 2003, entitled CURRENT MEASURING CIRCUIT SUITED FOR BATTERIES; U.S. Ser. No. 10/681,666, filed Oct. 8, 2003, entitled ELECTRONIC BATTERY TESTER WITH PROBE LIGHT; U.S. Ser. No. 11/207,419, filed Aug. 19, 2005, entitled SYSTEM FOR AUTOMATICALLY GATHERING BATTERY INFORMATION FOR USE DURING BATTERY TESTER/CHARGING, U.S. Ser. No. 11/356,443, filed Feb. 16, 2006, entitled ELECTRONIC BATTERY TESTER WITH NETWORK COMMUNICATION; U.S. Ser. No. 12/697,485, filed Feb. 1, 2010, entitled ELECTRONIC BATTERY TESTER; U.S. Ser. No. 12/769,911, filed Apr. 29, 2010, entitled STATIONARY BATTERY TESTER; U.S. Ser. No. 13/152,711, filed Jun. 3, 2011, entitled BATTERY PACK MAINTENANCE FOR ELECTRIC VEHICLE; U.S. Ser. No. 14/039,746, filed Sep. 27, 2013, entitled BATTERY PACK MAINTENANCE FOR ELECTRIC VEHICLE; U.S. Ser. No. 14/565,589, filed Dec. 10, 2014, entitled BATTERY TESTER AND BATTERY REGISTRATION TOOL; U.S. Ser. No. 15/017,887, filed Feb. 8, 2016, entitled METHOD AND APPARATUS FOR MEASURING A PARAMETER OF A VEHICLE ELECTRICAL SYSTEM; U.S. Ser. No. 15/049,483, filed Feb. 22, 2016, entitled BATTERY TESTER FOR ELECTRIC VEHICLE; U.S. Ser. No. 15/077,975, filed Mar. 23, 2016, entitled BATTERY MAINTENANCE SYSTEM; U.S. Ser. No. 15/149,579, filed May 9, 2016, entitled BATTERY TESTER FOR ELECTRIC VEHICLE; U.S. Ser. No. 16/253,526, filed Jan. 22, 2019, entitled HIGH CAPACITY BATTERY BALANCER; U.S. Ser. No. 17/136,600, filed Dec. 29, 2020, entitled INTELLIGENT MODULE INTERFACE FOR BATTERY MAINTENANCE DEVICE; U.S. Ser. No. 17/364,953, filed Jul. 1, 2021, entitled ELECTRICAL LOAD FOR ELECTRONIC BATTERY TESTER AND ELECTRONIC BATTERY TESTER INCLUDING SUCH ELECTRICAL LOAD; U.S. Ser. No. 17/504,897, filed Oct. 19, 2021, entitled HIGH CAPACITY BATTERY BALANCER; U.S. Ser. No. 17/739,393, filed May 9, 2022, entitled HYBRID AND ELECTRIC VEHICLE BATTERY PACK MAINTENANCE DEVICE; U.S. Ser. No. 17/750,719, filed May 23, 2022, entitled BATTERY MONITORING SYSTEM; U.S. Ser. No. 17/893,412, filed Aug. 23, 2022, entitled POWER ADAPTER FOR AUTOMOTIVE VEHICLE MAINTENANCE DEVICE; U.S. Ser. No. 18/166,702, filed Feb. 9, 2023, entitled BATTERY MAINTENANCE DEVICE WITH HIGH VOLTAGE CONNECTOR; U.S. Ser. No. 18/314,266, filed May 9, 2023, entitled ELECTRONIC BATTERY TESTER, U.S. Ser. No. 18/324,382, filed May 26, 2023, entitled STACKABLE BATTERY MAINTENANCE SYSTEM, U.S. Ser. No. 18/328,827, filed Jun. 5, 2023, entitled ELECTRIC VEHICLE BATTERY STORAGE VESSEL; U.S. Ser. No. 18/337,203, filed Jun. 19, 2023, entitled HIGH USE BATTERY PACK MAINTENANCE; all of which are incorporated herein by reference in their entireties.

Although the present invention has been described with reference to preferred embodiments, workers skilled in the art will recognize that changes may be made in form and detail without departing from the spirit and scope of the invention. Although specific embodiments describe increasing the load or current, it should be understood that the change in applied load or current drawn can be either increasing or decreasing

What is claimed is:

1. A transportable unit comprising:
an enclosure having a plurality of walls that enclose a storage space;
one or more batteries or battery packs located in the storage space of the enclosure; and
a battery maintenance system located in the storage space of the enclosure with the one or more batteries or battery packs, the battery maintenance system including a main unit having high voltage control circuitry coupled to the one or more batteries or battery packs through a high voltage junction box;
wherein the high voltage control circuitry is configured to charge the one or more batteries or battery packs during transport of the enclosure.

2. The transportable unit of claim 1, wherein the enclosure comprises an intermodal freight container.

3. The transportable unit of claim 1, wherein the high voltage control circuitry is further configured to discharge the one or more batteries or battery packs in the enclosure.

4. The transportable unit of claim 1, wherein the high voltage control circuitry is coupled to the high voltage junction box using Kelvin connectors.

5. The transportable unit of claim 1, wherein the one or more batteries or battery packs are coupled to the high voltage junction box through a single set of cable connections.

6. The transportable unit of claim 1, wherein the battery maintenance system is coupled to a power source for use in charging the one or more batteries or battery packs.

7. The transportable unit of claim 6, wherein the power source is located outside of the enclosure.

8. The transportable unit of claim 6, wherein the power source is located inside the enclosure.

9. A method of charging one or more batteries or battery packs during transport, the method comprising:
placing the one or more batteries or battery packs in a shipping container;
coupling the one or more batteries or battery packs to a battery maintenance system located inside the shipping container, wherein the battery maintenance system includes a main unit having high voltage control circuitry that is coupled to the one or more batteries or battery packs through a high voltage junction box;
charging the one or more batteries or battery packs with the high voltage control circuitry of the battery maintenance system during transport of the shipping container.

10. The method of claim 9, further comprising discharging the one or more batteries or battery packs with the high voltage control circuitry of the battery maintenance system during transport of the shipping container.

11. The method of claim 9, wherein coupling the one or more batteries or battery packs to the battery maintenance system through the high voltage junction box comprises using Kelvin connectors to couple the high voltage control circuitry to the high voltage junction box.

12. The method of claim 9, wherein coupling the one or more batteries or battery packs to the battery maintenance system through the high voltage junction box comprises using a single set of cable connections to couple the one or more batteries or battery packs to the high voltage junction box.

13. The method of claim 9, further comprising coupling the battery maintenance system to a power source to charge the one or more batteries or battery packs.

14. The method of claim 13, further comprising locating the power source outside the shipping container.

15. The method of claim 13, further comprising locating the power source inside the shipping container.

16. A transportable unit comprising:
a shipping container;
one or more batteries or battery packs located in the shipping container;
a battery maintenance system located in the shipping container and coupled the one or more batteries or battery packs, wherein the battery maintenance system includes a main unit having high voltage control circuitry that is coupled to the one or more batteries or battery packs through a high voltage junction box;
wherein the one or more batteries or battery packs are charged with the battery maintenance system during transport of the shipping container.

17. The transportable unit of claim 16, wherein the high voltage control circuitry is further configured to discharge the one or more batteries or battery packs in the enclosure.

18. The transportable unit of claim 16, wherein the high voltage control circuitry is coupled to the high voltage junction box using Kelvin connectors.

19. The transportable unit of claim 16, wherein the battery maintenance system is coupled to a power source for use in charging the one or more batteries or battery packs, wherein the power source is located outside the shipping container.

20. The transportable unit of claim 16, wherein the battery maintenance system is coupled to a power source for use in charging the one or more batteries or battery packs, wherein the power source is located inside the shipping container.
